(19) United States
(12) Patent Application Publication
(10) Pub. No.: US 2007/0104555 A1
(43) Pub. Date: May 10, 2007

(54) Replacement stud and setting tool for machine screw anchors

(75) Inventor: Randall S. Sly, Coral Springs, FL (US)

Correspondence Address: AKERMAN SENTERFITT, P.O. BOX 3188, WEST PALM BEACH, FL, 33402-3188, US

(73) Assignee: Davidson Hurricane Protection, Inc., Coral Springs, FL (US)

(21) Appl. No.: 11/270,086

(22) Filed: Nov. 9, 2005

(51) Int. Cl. F16B 33/00

(52) U.S. Cl. 411/378

(57) ABSTRACT

A stud (20) includes a shaft (24) having an integrated stop washer (26), helical threading (23 and 25) on opposing sides of the integrated stop washer, and an integral driver mechanism (22) having a diameter smaller than the diameter of the shaft. The stud can mate with a wing-nut (18) that can be placed over the integral driver mechanism. The stud can further include an integral fluted thread cleaning feature (32). The cleaning feature can clean the threads (14) on an anchor (17) having an inner sleeve (12) and an outer sleeve (16) as the stud is being threaded into the anchor. The stud can further include a compressible washer (28) abutting against the integrated stop washer. The stud 20 can further include an optional spacer (30) abutting against the compressible washer when under compression. The stud can serve as a setting tool for the machine screw anchor arrangement.

### FIELD OF THE INVENTION

This invention relates generally to studs, and more particularly to a replacement stud that can also serve as a setting tool for an existing machine screw anchor.

### BACKGROUND OF THE INVENTION

Many existing hurricane shutter systems employ sidewalk bolts or truss head bolts. Sidewalk bolts are particularly popular due to their aesthetic feature of being unobtrusive and substantially flush fitting when using embedded machine screw anchor systems. Such sidewalk bolt can even provide a fair water resistant barrier when painted over as is done in many newly built homes. Unfortunately, when a hurricane approaches, homeowners typically use handheld drills or driver tools that tend to over-drive sidewalk bolts in either the removal or replacement of the bolt back with the embedded anchor. The embedded anchor systems used with the sidewalk bolt are typically machine threaded. The process of removing and then placing back the sidewalk bolt (particularly using a handheld driver or drill tool) will typically cause stripping of threads and further cause any sealing function to become ineffective. In many instances, the act of removing the existing sidewalk bolt or truss head bolt will result in ineffective anchor systems that will fail to anchor to the wall they are intended to mate with.

Existing Tapcon Studs used to mount hurricane shutters to wood surfaces on homes use a wood screw thread and have machine screw threading on an external portion for convenient and easy placement and removal of shutters using a wing nut that threads on and off the machine screw threads. Unfortunately, the existing Tapcon studs cannot mate with existing machine screw anchor systems used in masonry that are typically used with sidewalk bolts and truss head bolts.

### SUMMARY OF THE INVENTION

Embodiments in accordance with the present invention can provide a stud that can be used to quickly and conveniently replace existing bolt systems that use machine screw anchors.

In a first embodiment of the present invention, a stud can include a shaft having an integrated stop washer, helical threading on opposing sides of the integrated stop washer, and an integral driver mechanism on a first end of the stud having a diameter smaller than the diameter of the shaft. The stud can further include an integral fluted thread cleaning feature on a second end of the stud and a compressible washer (such as a neoprene washer) abutting against the integrated stop washer. The stud can further include a spacer abutting against the compressible washer when under compression. The stud can mate with a wing-nut that can be placed over the integral driver mechanism on the first end which threads towards the integrated stop washer and a cap can cover at least a portion of the shaft on the first end. The stud can further include a chemical threadlocking agent towards a portion of the second end of the stud. Note, the second end can mate with a masonry machine screw wedge anchor and the stud can serve as a setting tool for the machine screw anchor. The stud can be made from any number of materials including for example zinc, stainless steel, Galvanized metal, and carbon steel. The shaft can essentially be any length or diameter and the pitch on the threading can also vary as needed in accordance with the embodiments herein although a typical arrangement can have a ¼ inch diameter and a 20 pitch helical or machine screw threading.

In a second embodiment of the present invention, a replacement stud system for use with a machine screw anchor can include a shaft having an integrated stop washer, machine screw threading on opposing sides of the integrated stop washer, an integral driver mechanism on a first end of the shaft having a diameter smaller than the diameter of the shaft, an integral fluted thread cleaning feature on a second end of the shaft, and a compressible washer (such as a neoprene washer) abutting against the integrated stop washer. The system can further include a spacer abutting against the compressible washer when under compression. The system can also include a wing-nut for placement over the integral driver mechanism on the first end threading towards the integrated stop washer. The system can further include the machine screw anchor that mates with the second end of the shaft such that the replacement stud system serves as a setting tool for the machine screw anchor.

In a third embodiment of the present invention, a method of replacing an existing machine screw threaded bolt (such as a sidewalk bolt or truss head bolt) that mates with a machine screw wedge anchor, can include the steps of setting the machine screw wedge anchor with a stud having a shaft with an integrated stop washer and machine screw threading on opposing sides of the integrated stop washer and cleaning machine screw threading on the machine screw wedge anchor using an integral fluted thread cleaning feature on a second end of the shaft as the shaft is threaded into the machine screw threading on the machine screw wedge anchor. The method further includes the step of sealing a hole formed in masonry by the machine screw wedge anchor using a compressible washer that abuts against the integrated stop washer as the stud is driven into the machine screw wedge anchor. The method can further include the step of driving the stud into the machine screw wedge anchor using an integral driver mechanism on a first end of the stud having a diameter smaller than the diameter of the shaft.

### BRIEF DESCRIPTION OF THE DRAWINGS

FIG. 1 is an exploded view of a stud replacement system in accordance with an embodiment of the present invention.

FIG. 2 is a flow chart illustrating a method of replacing a an existing machine screw threaded bolt that mates with a machine screw wedge anchor in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

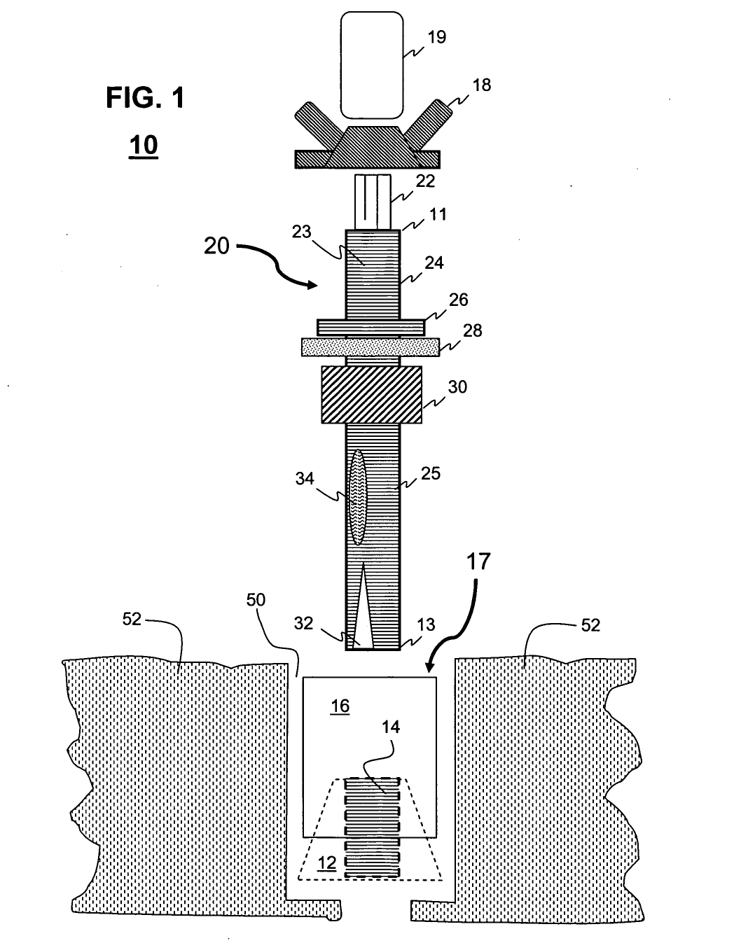

Referring to FIG. 1, an exploded view of a replacement stud system 10 is shown including a stud 20 in accordance with an embodiment of the present invention. The stud 20 can include a shaft 24 having an integrated stop washer 26, helical threading 23 and 25 on opposing sides of the integrated stop washer 26, and an integral driver mechanism 22 on a first end 11 of the stud having a diameter smaller than the diameter of the shaft. The diameter of the driver should be smaller than the diameter of the shaft to enable a wing-nut 18 or other type of nut to thread over threads 23. The stud 20 can mate with the wing-nut 18 that can be placed over the integral driver mechanism 22 on the first end which threads towards the integrated stop washer 26. The system 10 can further include a cap 19 that can cover at least a portion of the shaft 24 on the first end 11.

The stud 20 can further include an integral fluted thread cleaning feature 32 on a second end 13 of the stud 20. The feature 32 can clean the threads 14 on an existing or new anchor 17 having an inner sleeve 12 and an outer sleeve 16 as the stud 20 is being threaded into the anchor 17. The stud 20 can further include a compressible washer 28 (such as a neoprene washer) abutting against the integrated stop washer 26. The stud 20 can further include a spacer 30 abutting against the compressible washer 28 when under compression. The stud 20 can further include a chemical threadlocking agent 34 (such as Loctite) towards a portion of the second end 13 of the stud 20. Note, the second end 13 can mate with the masonry machine screw wedge anchor 17 and the stud 20 can serve as a setting tool for the machine screw anchor 17 by grabbing and wedging the inner sleeve 12 towards the outer sleeve 16 as the stud 20 threads into the anchor 17. The outer sleeve 16 on the anchor is typically made from lead and the inner sleeve 12 can be any number of materials such as pot metal, nickel alloys, zinc alloys, brass, or stainless steel. Note, the spacer 30 can assist in the wedging processes as the stud 20 threads into the anchor 17 by pushing the outer sleeve 16 towards the inner sleeve 12. The stud 20 can be made from any number of materials including for example zinc, stainless steel, Galvanized metal, and carbon steel. The shaft can essentially be any length or diameter and the pitch on the threading can also vary as needed in accordance with the embodiments herein although a typical arrangement can have a ¼ inch diameter and a 20 pitch helical or machine screw threading.

The system 10 can be a replacement stud system for use with a machine screw anchor that serves as a setting tool for the machine screw anchor. In this manner, a hurricane panel or shutter can be quickly installed by removing an existing bolt such as a sidewalk bolt and utilizing an existing anchor (or a new anchor, if needed) that was used for the sidewalk bolt and replacing the sidewalk bolt with the stud 20. The stud 20 will not only serve to set the machine screw anchor 17, but can clean the threads 14 on the machine screw anchor 17. A hole 50 in a surrounding wall 52 formed by the machine screw anchor 17 can also be sealed by the compressible washer 28 once the stud 20 is driven into the anchor 17. The compressible washer will form a water resistant barrier that is likely to be better than the barrier formed by a sidewalk bolt that it replaced.

In one specific embodiment, the stud 20 can include a ¼ inch 20 pitch machine screw thread on the shaft 24 with approximately ½ inch integral driver 22 protruding from the end 11. Note, the driver can also be recessed or slotted within the shaft 24 instead of protruding from the end 11. The integral washer 26 can be bonded or integrally formed on the shaft 24 and can have a diameter of ⅝ inches to 11/16 inches with an approximate thickness of 1/16 inches. The compressible washer 28 can be approximately 11/16 inches and 1/16 inches in thickness. The spacer 30 can be optional and can have a ½ inch diameter and ⅞ inch depth. The stud 20 can be approximately ⅛ inch shorter (excluding the driver mechanism 22) than the bolt it is likely to replace.

Note, the integral driver allows the wing-nut to pull flush to a hurricane shutter panel and to pull the panel flush to a wall. The integral washer can not only serve as a stop, but can serve to cover an existing hole in the masonry while the compressible washer provides greater sealing of the existing hole from water intrusion and other elements. The spacer ensures the embedment of the machine screw anchor in the masonry while the fluted tap can ensure the cleaning of threads in the anchor. Also, an optional drill tip can clean the path in masonry behind the embedded anchor. The threadlocking agent can ensure a solid bond to the embedded anchor.

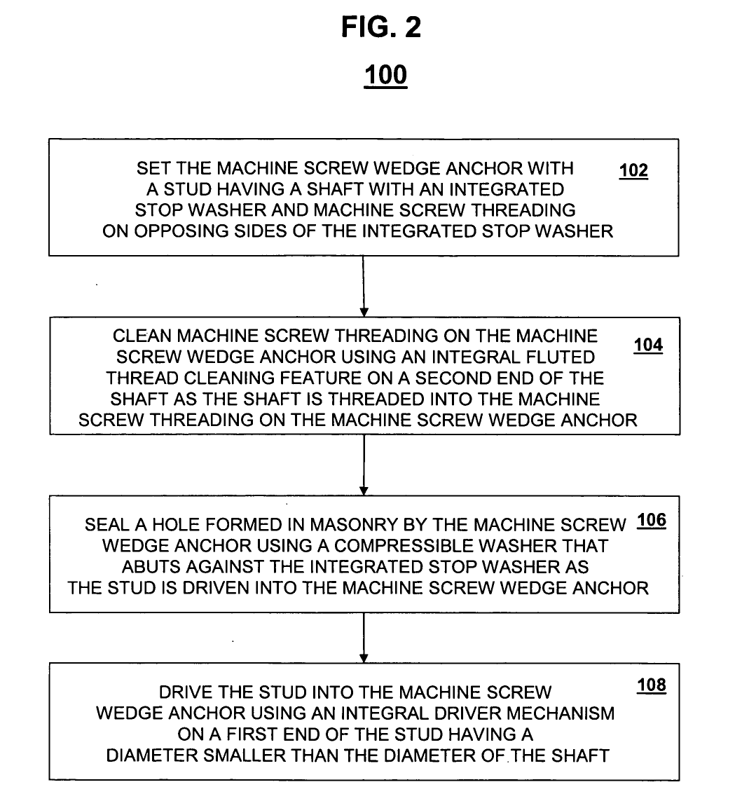

Referring to FIG. 2, a flow chart illustrating a method 100 of replacing an existing machine screw threaded bolt (such as a sidewalk bolt or truss head bolt) that mates with a machine screw wedge anchor is shown. The method 100 can include the step 102 of setting the machine screw wedge anchor with a stud having a shaft with an integrated stop washer and machine screw threading on opposing sides of the integrated stop washer and cleaning at step 104 the machine screw threading on the machine screw wedge anchor using an integral fluted thread cleaning feature on a second end of the shaft as the shaft is threaded into the machine screw threading on the machine screw wedge anchor. The method 100 can further include the step 106 of sealing a hole formed in masonry by the machine screw wedge anchor using a compressible washer that abuts against the integrated stop washer as the stud is driven into the machine screw wedge anchor. The method 100 can further include the step 108 of driving the stud into the machine screw wedge anchor using an integral driver mechanism on a first end of the stud having a diameter smaller than the diameter of the shaft.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A stud, comprising:
a shaft having an integrated stop washer;
helical threading on opposing sides of the integrated stop washer;
an integral driver mechanism on a first end of the stud having a diameter smaller than the diameter of the shaft;
an integral fluted thread cleaning feature on a second end of the stud; and
a compressible washer abutting against the integrated stop washer.

2. The stud of claim 1, wherein the stud further comprises a spacer abutting against the compressible washer when under compression.

3. The stud of claim 1, wherein the stud further comprises a wing-nut for placement over the integral driver mechanism on the first end threading towards the integrated stop washer.

4. The stud of claim 1, wherein the stud further comprises a cap for covering at least a portion of the shaft on the first end.

5. The stud of claim 1, wherein the stud further comprises a chemical threadlocking agent towards a portion of the second end of the stud.

6. The stud of claim 1, wherein the second end mates with a masonry machine screw wedge anchor.

7. The stud of claim 1, wherein the shaft is ¼ inch in diameter and the helical threading is 20 pitch.

8. The stud of claim 1, wherein the compressible washer is a neoprene washer.

9. The stud of claim 1, wherein the stud serves as a setting tool for a machine screw anchor.

10. The stud of claim 1, wherein the stud is made from a material selected from the group comprising zinc, stainless steel, Galvanized metal, and carbon steel.

11. A replacement stud system for use with a machine screw anchor, comprising:
a shaft having an integrated stop washer;
machine screw threading on opposing sides of the integrated stop washer;
an integral driver mechanism on a first end of the shaft having a diameter smaller than the diameter of the shaft;
an integral fluted thread cleaning feature on a second end of the shaft; and
a compressible washer abutting against the integrated stop washer.

12. The system of claim 11, wherein the system further comprises a spacer abutting against the compressible washer when under compression.

13. The system of claim 11, wherein the system further comprises a wing-nut for placement over the integral driver mechanism on the first end threading towards the integrated stop washer.

14. The system of claim 11, wherein the system further comprise the machine screw anchor that mates with the second end of the shaft such that the replacement stud system serves as a setting tool for the machine screw anchor.

15. The system of claim 11, wherein the shaft is ¼ inch in diameter and the machine screw threading is 20 pitch.

16. The system of claim 11, wherein the compressible washer is a neoprene washer.

17. The system of claim 11, wherein the shaft is made from a material selected from the group comprising zinc, stainless steel, Galvanized metal, and carbon steel.

18. A method of replacing an existing machine screw threaded bolt that mates with a machine screw wedge anchor, comprising the step of:
setting the machine screw wedge anchor with a stud having a shaft with an integrated stop washer and machine screw threading on opposing sides of the integrated stop washer;
cleaning machine screw threading on the machine screw wedge anchor using an integral fluted thread cleaning feature on a second end of the shaft as the shaft is threaded into the machine screw threading on the machine screw wedge anchor; and
sealing a hole formed in masonry by the machine screw wedge anchor using a compressible washer that abuts against the integrated stop washer as the stud is driven into the machine screw wedge anchor.

19. The method of claim 18, wherein the method further comprises the step of driving the stud into the machine screw wedge anchor using an integral driver mechanism on a first end of the stud having a diameter smaller than the diameter of the shaft.

20. The method of claim 18, wherein the method further comprise the step of replacing at least one among a sidewalk bolt and a truss head bolt.
